(19) United States
(12) Patent Application Publication
(10) Pub. No.: US 2026/0236587 A1
(43) Pub. Date: Aug. 13, 2026

(54) PROACTIVE SECURITY ASSESSMENT WITH AGENT-BASED CYBERSECURITY DEPLOYMENT

(71) Applicant: Metabase Q, Inc., San Francisco, CA (US)

(72) Inventors: Federico Nan, Los Angeles (CL); Mauricio Benavides, CDMX (MX); Jorge Damián Failla, Entre Ríos (AR); Louise Ireland, San Francisco, CA (US)

(73) Assignee: Metabase Q, Inc., San Francisco, CA (US)

(21) Appl. No.: 19/365,314

(22) Filed: Oct. 22, 2025

Related U.S. Application Data
(63) Continuation-in-part of application No. 18/948,608, filed on Nov. 15, 2024.
(60) Provisional application No. 63/599,884, filed on Nov. 16, 2023.
(60) Provisional application No. 63/711,191, filed on Oct. 24, 2024.

(51) Int. Cl. G06F 21/57; G06F 21/54

(52) U.S. Cl. CPC G06F 21/577; G06F 21/54; G06F 2221/034

(57) ABSTRACT

A software agent is installed on each endpoint device within a plurality of endpoint devices. Each software agent manages a unique endpoint device. Each software agent is communicatively coupled to an orchestration software component. The software agents monitor security activities on each endpoint device and send security information details on each endpoint device to the orchestration software. The orchestration software generates security categories and a compliance score in each category for each endpoint device. The orchestration software creates a proactive security score (PSS) for each endpoint device, based on the security information compliance scores. The orchestration software generates a global proactive security score (GPSS) based on the average PSS for the plurality of endpoint devices. The orchestration software reports the PSS and GPSS for the plurality of endpoint devices.

### RELATED APPLICATIONS

This application claims the benefit of U.S. provisional patent application “Proactive Security Assessment With Agent-Based Cybersecurity Deployment” Ser. No. 63/711,191, filed Oct. 24, 2024.

This application is also a continuation-in-part of U.S. patent application “Orchestration Of Agent-Based Cybersecurity Endpoint Deployments” Ser. No. 18/948,608, filed Nov. 15, 2024, which claims the benefit of U.S. provisional patent applications “Orchestration Of Agent-Based Cybersecurity Endpoint Deployments” Ser. No. 63/599,884, filed Nov. 16, 2023, and “Proactive Security Assessment With Agent-Based Cybersecurity Deployment” Ser. No. 63/711,191, filed Oct. 24, 2024.

Each of the foregoing applications is hereby incorporated by reference in its entirety.

### FIELD OF ART

This application relates generally to endpoint security and more particularly to proactive security assessment with agent-based cybersecurity deployment.

### BACKGROUND

Since the times of antiquity, people have desired protection and security for their data, especially for their communications. One early example of this was the simple letter-substitution cipher said to be eponymously adopted by Julius Caesar to encrypt messages to his battlefield commanders. This early example of communications security has paved the way for millennia of development of various techniques to keep communications secure, protected from ever-present malicious actors who would benefit in some way from the unauthorized divulgation of such communications. From the childhood practice of speaking in “pig Latin” to the elaborate encryption schemes employed by modern data scientists, keeping communications secure has become almost a societal obsession. The need for communications security is also just as applicable for data security. After all, communications are a form of data, and as societies have progressed technologically, huge amounts of data are being generated and huge amounts of data need to have at least a modicum of data security implemented.

Much more recently, with the advent of digital data storage and manipulation, the desire for communication security has spread to data security. For example, because our bank accounts are fundamentally data based (with some measure of actual cash reserves maintained somewhere within a plethora of digital systems, including at the Federal Reserve), the need for data security is absolutely critical. And, even though elaborate systems of data security have been put in place, there is constant news of account hacking, ATM pin stealing, scam emails and phone calls, and so on. Who doesn't feel sympathy for an elderly person whose bank account has been coopted in some manner and whose life savings has been lost due to some manner of data insecurity. The fact that almost every facet of our lives is touched, managed, stored, controlled, or overseen by a digital data system means that data security has become an absolutely fundamental need for a modern society to function safely, efficiently, and predictably.

All this leads to an inescapable conclusion: computer systems require security. This has been the case since computers were developed during World War II. At first, the focus was on physical security. Access to the computer equipment was limited to those authorized and capable of working with them. The computer equipment itself was located in the midst of buildings with secure doors, locks, and guards when necessary. Later, as time sharing emerged, usernames and passwords were used to ensure that those with access to workstations were permitted to use them. However, to detriment of law-abiding citizens, even these measures have not been able to stay very far ahead of malicious activities. Bad actors are continuously developing and refining methods for sabotaging computer systems, corrupting and/or stealing data, destroying programs or physical devices, gaining malicious system or application entry, and so on. One thing is sure, and that is, as computer systems have grown more complex and interconnected and have more and more critical data stored on them, more and more advanced security will be required.

### SUMMARY

Network security is a never-ending, evolving process, requiring coordinated efforts in order to protect all points of a network. Detecting and investigating suspicious activity, keeping user devices up to date, deploying updates and patches, monitoring software activity, and reporting progress to users and security staff are all vital functions in providing comprehensive security maintenance. Most computer networks today deploy multiple layers of hardware and software in order to provide a security umbrella for end users and devices across a network, regardless of where they are located or how they connect. The software programs and agents installed on endpoints in order to keep these devices up to date and monitor them for any signs of problems often come from multiple vendors. Keeping the applications on the endpoints current and coordinating efforts when a problem or even a suspicious activity occurs can be challenging. Orchestrating the responses to a suspicious action across one or multiple endpoint devices can require coordination, flexibility, and solid communications with many third-party applications simultaneously. Understanding the status of endpoint devices as various security measures are established and implemented can be challenging as well, requiring information at both a summary and detail level.

Techniques for proactive security assessment with agent-based cybersecurity deployment are disclosed. A software agent is installed on each endpoint device within a plurality of endpoint devices. Each software agent manages a unique endpoint device. Each software agent is communicatively coupled to an orchestration software component. The software agents monitor security activities on each endpoint device and send security information details on the endpoint device to the orchestration software. The orchestration software generates security categories and a compliance score in each category for each endpoint device. The orchestration software creates a proactive security score (PSS) for each endpoint device, based on the security information compliance scores. The orchestration software generates a global proactive security score (GPSS) based on the average PSS for the plurality of endpoint devices. The orchestration software reports the PSS and GPSS for the plurality of endpoint devices.

A processor-implemented method for endpoint security is disclosed comprising: installing a software agent on each endpoint device within a plurality of endpoint devices, wherein each software agent manages a unique endpoint device within the plurality of endpoint devices, and wherein each software agent is communicatively coupled to an orchestration software component running on a compute device; monitoring, by a first software agent installed on a first endpoint device within the plurality of endpoint devices, one or more security activities on the first endpoint device; sending, to the orchestration software, by the first software agent, a plurality of security information details, wherein the plurality of security information details is based on the monitoring; creating, by the orchestration software, a first proactive security score (PSS) for the first endpoint device, wherein the PSS is based on the plurality of security information details; and reporting, to a user, by the orchestration software, the first PSS for the first endpoint device. Some embodiments comprise associating the plurality of security information details with one or more security categories. Some embodiments comprise generating, for each security category in the one or more security categories, a compliance score. In embodiments, each compliance score is based on a security standard. In embodiments, each compliance score is associated with the first endpoint device. In embodiments, the first PSS is based on a weighted average of each compliance score that was generated.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for proactive security assessment with agent-based cybersecurity deployment.

FIG. 2 is a flow diagram for score management.

FIG. 3 is an infographic for agent-based cybersecurity deployment.

FIG. 4 is an example of monitoring coverage of installed third-party software.

FIG. 5 is an example of blocking suspicious activity.

FIG. 6 is an example graphical user interface for presenting proactive security scores.

FIG. 7 is a system diagram for proactive security assessment with agent-based cybersecurity deployment.

### DETAILED DESCRIPTION

Computer security is an ongoing endeavor for individuals and organizations alike. Threats can come from competitors, governments, private groups, organized crime, disgruntled employees, or from simple mistakes made by regular users. As a result, it is now routine for a network to devote more time, money, and computing resources to cybersecurity than to core business applications and operations. Network endpoint devices, whether wired or wireless, can have several different security applications installed, often from third parties and in some cases with overlapping features and functions. Coordinating the efforts of the different applications on endpoint devices in order to maintain and protect users and their systems can be a challenge. In addition, audit and compliance departments, board members, investors, directors, and employees all have vested interest in the efforts made to keep computer software and devices secure. Keeping these various groups up to date on the progress of security efforts and the effectiveness of cybersecurity processes and procedures can be a daunting task.

Techniques for proactive security assessment with agent-based cybersecurity deployment are disclosed. A software agent can be installed on each endpoint device that participates in a network. Each software agent manages a unique endpoint device and can communicate with orchestration software running on a compute device such as a server, cloud server, mobile device, or specialty appliance. The software agent can monitor and communicate with the endpoint device operating system, hardware drivers, and third-party security software applications installed on the device. The information collected by the software agent can be forwarded to the orchestration software and can be uniquely associated with the endpoint device. The orchestration software can group the information collected by the software agents into various security categories, such as anti-virus, anti-malware, advanced persistent threat (APT), and so on. The orchestration software can also score each endpoint device as to how well the device is complying with hardware and software security procedures and policies. A proactive security score, or PSS, can be assigned to each endpoint device, based on the level of compliance the device shows in the various security categories. The PSS can be a single percentage score that summarizes the overall readiness a particular endpoint has to face internal and external security threats. The PSS score of all endpoint devices can be averaged together to create a global proactive security score (GPSS) summarizing the readiness of the entire network. The GPSS can give a single number to use as a gauge, indicating whether cybersecurity policies and procedures are moving the organization in the right direction. The orchestration software allows users to drill down into the GPSS or PSS scores of individual endpoints or groups of endpoints in order to analyze areas of concern and deploy solutions to improve the preparedness of the network and allow the organization to focus on its primary mission.

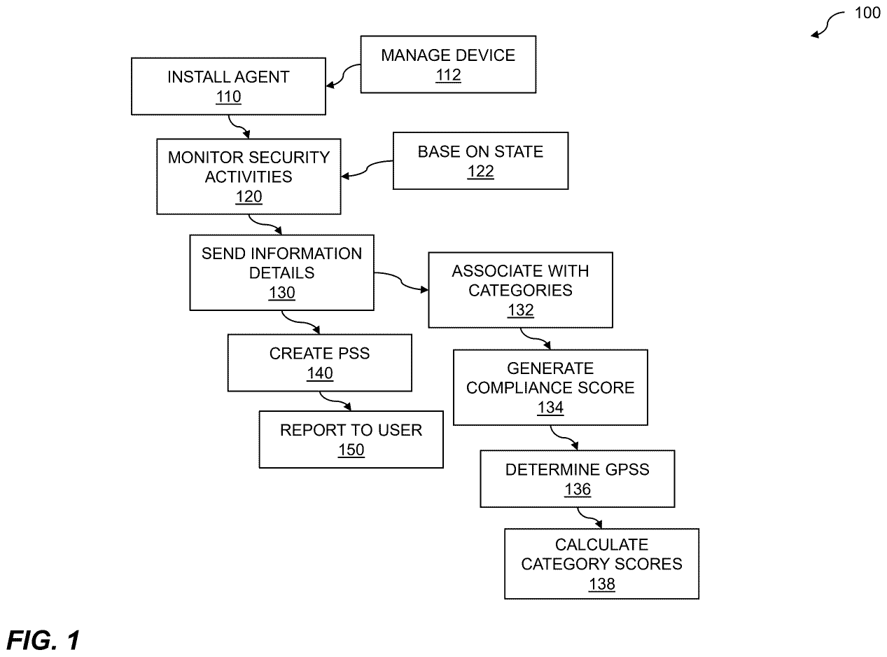

FIG. 1 is a flow diagram for proactive security assessment with agent-based cybersecurity deployment. The flow 100 includes installing 110 a software agent on each endpoint device within a plurality of endpoint devices. A software agent can be a computer program that can act with a level of autonomy under a defined set of circumstances. Software agents can be persistent—they can be proactive and reactive, and they can act independently or in collaboration with other software components on the same device or other devices. Each software agent manages 112 a unique endpoint device within the plurality of endpoint devices. The endpoint devices can be personal computers, laptops, thin-client workstations, tablets, mobile phones, Internet of Things (IoT) devices, network components, and so on. The endpoint device connections can be wired or wireless. Each software agent is communicatively coupled to an orchestration software component running on a compute device. The communicative coupling can be included in a network. The network environment can be local, cloud, hybrid clouds, etc.

The flow 100 includes monitoring 120, by a first software agent installed on a first endpoint device within the plurality of endpoint devices, one or more security activities on the first endpoint device. The security activities can be associated with various items. For example, the security activities can be associated with various third-party applications. The security activities can also be based on the state 122 of an endpoint device within the plurality of endpoint devices. In embodiments, the one or more security activities that were monitored are associated with one or more third-party applications. The monitoring can include reviewing log entries generated by the third-party applications, communications sent to or from the third-party application to a server or cloud-based control application, alerts generated by a third-party agent on the endpoint device, and so on. In embodiments, the one or more security activities that were monitored are based on a state of the first endpoint device. The state of the first endpoint device can include the power state of the device, network activity, drivers loaded or active, applications in memory, drive activity, and so on. The first endpoint device state information can be used to determine when third-party software processes, such as virus scans or patch installations, can be executed. The state information can be used to determine whether or not an endpoint device is attached to the network and available for scanning or updating, and so on.

The flow 100 includes sending 130, to the orchestration software, by the first software agent, a plurality of security information details. The plurality of security information is based on the monitoring. The plurality of security information details can include the endpoint device hostname, IP address, kernel, agent version, agent status, most recent internet connection, and so on. Information about the type of endpoint device, operating system, network connection, physical location, etc. can be included in the plurality of security information details. The plurality of security information details can be refreshed based on a schedule established by the orchestration software. Alerts and other responses to suspicious activity or security incidents can be sent to the orchestration software as soon as the responses are generated by the software agent on the endpoint device. The first software agent can communicate with the orchestration software asynchronously. This can allow the orchestration software the ability to communicate with multiple endpoint devices simultaneously and coordinate actions to remedy security incidents quickly and efficiently.

In embodiments, the flow 100 further comprises associating 132 the plurality of security information details with one or more security categories. Security categories can include anti-ransomware, anti-virus, endpoint detection and response (EDR), advanced persistent threat (APT), incidence response, patching, security information and event management (SIEM), cloud security information and event management, operating system (OS), and so on. In embodiments, the flow 100 further comprises generating 134, for each security category in the one or more security categories, a compliance score. Each compliance score can be based on a security standard. For example, an anti-malware security standard can include installation of an anti-malware security application, automatic execution of the security application on start-up, patch level of the application, and patch level of the anti-malware library. An endpoint device that has the anti-malware security application loaded and running but is using an older version of the application or an older anti-malware library might receive an 80% compliance score. The security standard can be associated with internal policies; regulatory, audit, or third-party organization recommendations; and so on. The security standards can include the ISO 27000 series, NIST SP 800-53, NIST SP 800-171, COBIT, CIS Version 8, HITRUST, and so on. Recommendations from the third-party application vendor can be used as a security standard. Each compliance score is associated with the first endpoint device.

The flow 100 includes creating 140, by the orchestration software, a first proactive security score (PSS) for the first endpoint device. The PSS is based on the plurality of security information details. In embodiments, the first PSS is based on a weighted average of each compliance score that was generated. In embodiments, the one or more security categories include coverage. In embodiments, the one or more security categories include compliance. In embodiments, the one or more security categories include operating system (OS) updates. In embodiments, the one or more security categories include advanced persistent threat (APT) mitigation. In embodiments, the one or more security categories include an inventory. The weighted average can be adjusted based on internal policies, compliance policies, third-party software recommendations, audit standards, and so on. For example, adherence to operating system configuration requirements can be weighted more highly than hardware age or network speed, and so on.

In embodiments, the monitoring, the sending, the creating, and the reporting include a second endpoint device. In embodiments, the creating includes a second PSS for the second endpoint device. In practice, a software agent can be installed on every endpoint device being monitored by the orchestration software. Each endpoint device can be monitored and controlled by the orchestration software based on security information received from the installed software agent. Thus, the flow 100 can include monitoring, by a second software agent installed on a second endpoint device within the plurality of endpoint devices, an activity by one or more third-party applications on the second endpoint device; sending, to the orchestration software, by the second software agent, a plurality of security information details, wherein the plurality of security information details includes the activity that was monitored; creating, by the orchestration software, a proactive security score (PSS) for the second endpoint device, based on the plurality of security information details from the second software agent; and reporting of the second PSS of the second endpoint device. In this way, the entire network can be monitored. In some embodiments, the installation of a software agent on every endpoint device can enable the orchestration software to report an action, take an action, or update software on any endpoint device in the network.

The flow 100 further comprises determining 136 a global proactive security score (GPSS), wherein the GPSS comprises an average of the first PSS and the second PSS. The GPSS can comprise an average of the PSS of every endpoint included in the network which includes the orchestration software. The GPSS can be calculated for various subsets of the endpoint population as well. For example, all endpoint devices within a particular department, building, or region can be calculated. The GPSS for all endpoint devices of a particular manufacturer or over a particular age can be calculated, and so on. The GPSS can be used to report to executive management, compliance, or audit departments in order to summarize security policy efforts and track changes in security readiness in response to various efforts within an organization.

In embodiments, the generating includes a second compliance score, wherein the second compliance score is associated with the second endpoint device. As with the GPSS, an aggregate compliance score can be calculated for the second and any other endpoint device in the network which includes the orchestration software. In embodiments, the flow 100 further comprises calculating 138 one or more security category scores. The one or more security category scores comprise, for each security category in the one or more security categories, an average of the compliance score and the second compliance score. The security category scores can be averaged for the entire endpoint device population, as well as various subsets of the device population such as departments, regions, classes of endpoint devices, and so on.

The flow 100 includes reporting 150, to a user, by the orchestration software, the first PSS for the first endpoint device. The reporting can be generated for the first endpoint device, the second endpoint device, or any endpoint device within the network which includes the orchestration software. The reporting can be generated for the entire endpoint device population as well as various subsets of the endpoint device population. The reporting can be generated in various formats, including print, pdf, html, txt, csv, and so on. The reporting can include a graphical user interface (GUI). The reporting can be presented in screen formats (described below). The reporting can be generated dynamically. The reporting can be generated on one or more schedules supplied by an orchestration software user or administrator.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

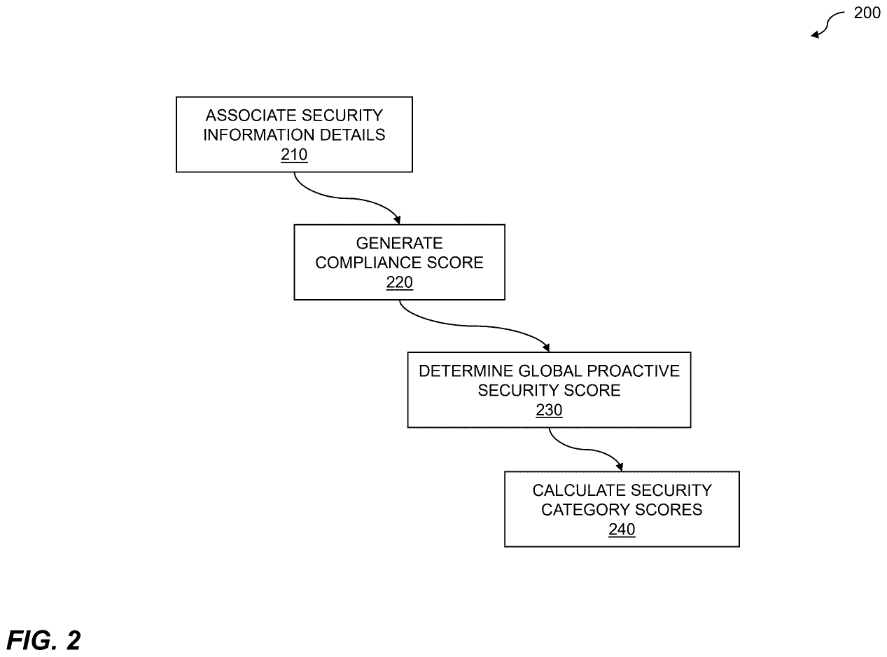

FIG. 2 is a flow diagram for score management. Score management can enable proactive security assessment with agent-based cybersecurity deployment. A software agent is installed on each endpoint device within a plurality of endpoint devices. Each software agent manages a unique endpoint device. Each software agent is communicatively coupled to an orchestration software component. The software agents monitor security activities on each endpoint device and send security information details on the endpoint device to the orchestration software. The orchestration software generates security categories and a compliance score in each category for each endpoint device. The orchestration software creates a proactive security score (PSS) for each endpoint device, based on the security information compliance scores. The orchestration software generates a global proactive security score (GPSS) based on the average PSS for the plurality of endpoint devices. The orchestration software reports the PSS and GPSS for the plurality of endpoint devices.

The flow 200 includes associating security information details 210 with one or more security categories. As discussed above and throughout, security categories can include anti-ransomware, anti-virus, endpoint detection and response (EDR), advanced persistent threat (APT), incidence response, patching, security information and event management (SIEM), cloud security information and event management, operating system (OS), and so on. The flow 200 includes generating a compliance score 220 for each security category. The compliance score can be based on various metrics, such as a cybersecurity security standard.

The flow 200 includes determining a global proactive security score 230. The global proactive security score can comprise an average of individual proactive security scores for two or more endpoints. The flow 200 includes calculating security category scores 240. The calculated security category score can comprise an average of compliance scores within a security category. Some embodiments comprise associating the plurality of security information details with one or more security categories. Some embodiments comprise generating, for each security category in the one or more security categories, a compliance score. Some embodiments comprise determining a global proactive security score (GPSS). In embodiments, the GPSS comprises an average of a first PSS and a second PSS. Some embodiments comprise calculating one or more security category scores.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

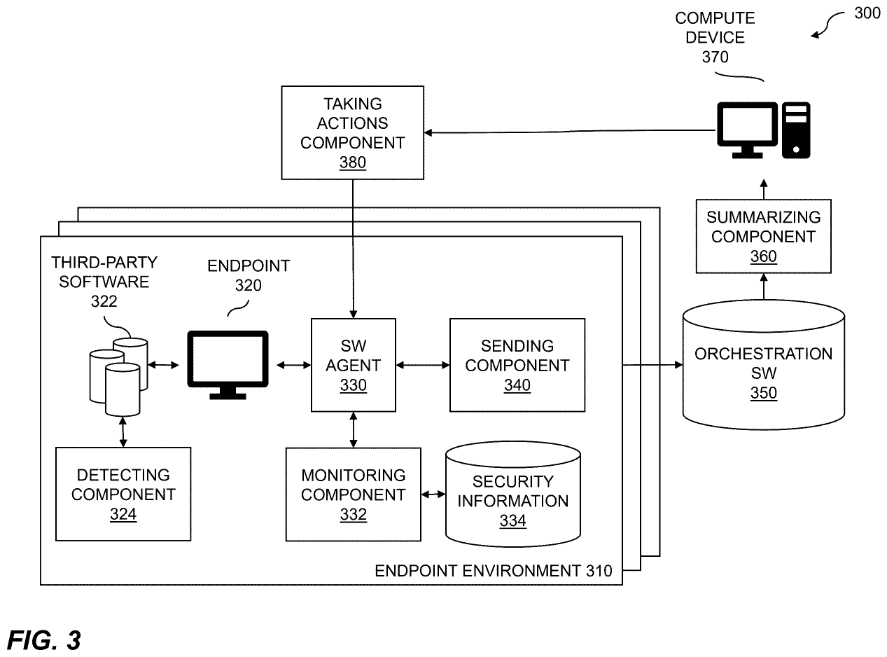

FIG. 3 is an infographic for agent-based cybersecurity deployment. Agent-based cybersecurity deployment can enable proactive security assessment. A software agent is installed on each endpoint device within a plurality of endpoint devices. Each software agent manages a unique endpoint device. Each software agent is communicatively coupled to an orchestration software component. The software agents monitor security activities on each endpoint device and send security information details on the endpoint device to the orchestration software. The orchestration software generates security categories and a compliance score in each category for each endpoint device. The orchestration software creates a proactive security score (PSS) for each endpoint device, based on the security information compliance scores. The orchestration software generates a global proactive security score (GPSS) based on the average PSS for the plurality of endpoint devices. The orchestration software reports the PSS and GPSS for the plurality of endpoint devices.

The infographic 300 includes an endpoint environment 310 and an endpoint device 320. In practice, a plurality of endpoint devices can be included in the endpoint environment 310. The endpoint environment 310 can include a plurality of endpoint devices that can participate in a computer network. The endpoint environment 310 can include endpoint devices, software programs or agents running on the endpoint devices, and so on. The endpoint device 320 can be a personal computer, laptop, thin-client workstation, tablet, mobile phone, IoT device, etc. The endpoint device connections to the network can be wired or wireless. The network environment can be local, cloud, hybrid clouds, etc. The network can be a combination of network devices, including routers, switches, firewalls, servers, storage devices, printers, user workstations, endpoint devices, and so on.

In embodiments, a software agent 330 is installed on each endpoint device within a plurality of endpoint devices, wherein each software agent remotely manages a unique endpoint device 320 within the plurality of endpoint devices, and wherein each software agent is communicatively coupled to orchestration software component 350 running on a compute device 370. A software agent 330 is a computer program that can act with a level of autonomy under a defined set of circumstances. In embodiments, the software agent can send and receive messages from the orchestration software. The compute device 370 hosting the orchestration software can be a mobile device.

The infographic 300 includes providing software access, wherein the software access enables one or more third-party applications 322, and wherein the one or more third-party applications communicate with each software agent 330 installed on the plurality of endpoint devices. In embodiments, the providing can include an application programming interface (API) to the one or more third-party applications 322. The software access allows the software agent 330 to communicate with or control the one or more third-party applications 322. The third-party applications can interact with the software agent, the orchestration software 350, or a user. The third-party applications can accept and execute commands from the software agent, generate reports and logs, communicate with other applications, and so on without requiring a separate login or user access session. The API interface to the third-party applications allows the software agent and the orchestration software to monitor and control the third-party applications without invoking a separate application session for the third-party programs on the endpoint device.

The infographic 300 includes a monitoring component 332. The monitoring component 332 can include monitoring, by a first software agent 330 installed on a first endpoint device 320 within the plurality of endpoint devices, an activity by the one or more third-party applications 322 on the first endpoint device. The monitoring can include reviewing log entries generated by the third-party applications 322, security information 334 gathered by the third-party applications, communications sent to or from the third-party application to a server or cloud-based control application, alerts generated by a third-party agent on the endpoint device, and so on. In embodiments, the monitoring can include checking, by the first software agent, compliance of the first endpoint device against a security standard. The security standard can be associated with internal policies; regulatory, audit, or third-party organization recommendations; and so on. Recommendations from one or more third-party application vendors can be used as a security standard. The checking can be based on a schedule. The schedule can be set for individual third-party applications or can be based on a standard for application types.

The infographic 300 includes a detecting component 324. The detecting component 324 can detect, on the first endpoint device 320 by the one or more third-party applications 322, a suspicious activity on the first endpoint device. In embodiments, the monitoring can include detecting the state of the one or more third-party applications running on the first endpoint device. The state of the one or more third-party applications can include an identification of a suspicious activity, a software version, or a connection status. For example, the application state can show normal operation, an error message, communications problems, and so on. The version of the third-party application; install date, hours, or days of continuous operations; and so on can be included in the program state information. In embodiments, alerts or other responses to suspicious activity can be generated by the third-party applications 322 and monitored by the software agent 330 and control applications or devices associated with the third-party application at the same time.

The infographic 300 includes a sending component 340. The sending component 340 includes sending, to the orchestration software 350, by the first software agent 330, a plurality of security information 334 details, wherein the plurality of security information details includes the activity that was monitored. In embodiments, the plurality of security information 334 details includes the endpoint device hostname, IP address, kernel, agent version, agent status, or most recent internet connection. Information about the type of endpoint device, operating system, network connection, physical location, and so on can be included in the security information details. The security information details can be refreshed based on a schedule established by the orchestration software. Alerts and other responses to suspicious activity or security incidents can be sent to the orchestration software 350 as the responses are generated by the software agent on the endpoint device. In embodiments, the software agents 330 installed on unique endpoint devices 320 in the endpoint environment 310 can communicate with the orchestration software asynchronously. This allows the orchestration software the ability to communicate with multiple endpoint devices simultaneously and coordinate actions to remedy security incidents quickly and efficiently.

The infographic 300 includes a summarizing component 360. The summarizing component 360 includes summarizing, by the orchestration software 350, the plurality of security information 334 details from the first software agent 330. The summarizing can include the state of the one or more third-party applications 322 running on the first endpoint device 320. The state of the one or more third-party applications can include an identification of a suspicious activity, a software version, or a connection status. In embodiments, the summarizing component 360 can include security information details from multiple endpoint devices included in the endpoint environment 310. Summarized information can include the number of endpoint devices on the network, number of active endpoint devices, number of security related events, number of blocked commands, number of allowed commands, and so on. The summary of endpoint devices can include groups based on the type of device, departments, locations, types of incidents reported, and so on. A user can review the summarized categories and expand the summary to view details down to the individual endpoint device.

The infographic 300 includes a taking actions component 380. The taking actions component 380 includes taking an action, on the first endpoint device 320, wherein the action is based on the summarizing 360, wherein the action is initiated by the orchestration software 350, and wherein the action is performed by the first software agent 330. In embodiments, the action can be responsive to a security incident, wherein the action includes isolating the first endpoint device. The orchestration software can remove the endpoint device from the network, shut down specific applications or services on the device, isolate specific files, or programs, move files to a separate drive or device for research, and so on. In some embodiments, the orchestration software can take preemptive measures to prevent a security incident from spreading to other endpoint devices with similar characteristics. For example, all like endpoint devices in the same department as the first endpoint device can be isolated from the network, all endpoint devices running the same third-party application can be shut down, specific services on the endpoint devices can be disabled, and so on. The actions can include adding, updating, or removing software on the plurality of endpoint devices. The result is a set of coordinated actions being taken across the endpoint environment to prevent security threats and to respond to incidents in a timely and comprehensive manner when they occur. The various third-party applications are orchestrated to work together and deal with security threats quickly and thoroughly.

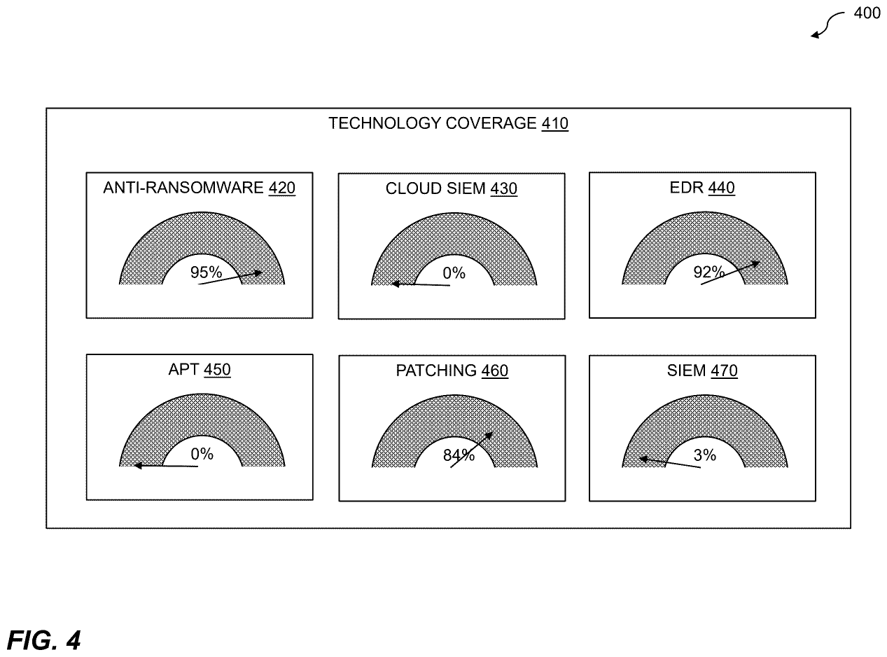

FIG. 4 is an example of monitoring coverage of installed third-party software. Monitoring coverage can be enabled by proactive security assessment with agent-based cybersecurity deployment. A software agent is installed on each endpoint device within a plurality of endpoint devices. Each software agent manages a unique endpoint device. Each software agent is communicatively coupled to an orchestration software component. The software agents monitor security activities on each endpoint device and send security information details on the endpoint device to the orchestration software. The orchestration software generates security categories and a compliance score in each category for each endpoint device. The orchestration software creates a proactive security score (PSS) for each endpoint device, based on the security information compliance scores. The orchestration software generates a global proactive security score (GPSS) based on the average PSS for the plurality of endpoint devices. The orchestration software reports the PSS and GPSS for the plurality of endpoint devices.

The example 400 includes technology coverage 410 of one or more endpoint devices within a plurality of endpoint devices. In embodiments, each unique endpoint device can include an installed software agent that is communicatively coupled to an orchestration software running on a compute device. Each software agent can access the installed third-party and internal applications and monitor the applications. The monitoring can include reviewing log entries generated by the third-party applications, communications sent to or from the third-party application to a server or cloud-based control application, alerts generated by a third-party agent on the endpoint device, and so on. In embodiments, the technology coverage 410 includes monitoring, by a first software agent installed on a first endpoint device within the plurality of endpoint devices, activities by one or more third-party applications on the first endpoint device. The monitoring further comprises monitoring, by a second software agent installed on a second endpoint device within the plurality of endpoint devices, an activity by one or more third-party applications on the second endpoint device; sending, to the orchestration software, by the second software agent, a plurality of security information details, wherein the plurality of security information details includes the activity that was monitored; and summarizing, by the orchestration software, the plurality of security information details from the second software agent. In embodiments, a software agent can be installed on every endpoint device included in the network being monitored by the orchestration software. Each endpoint device can be monitored and controlled by the orchestration software based on security information received from the installed software agent.

In embodiments, the monitoring comprises checking, by the one or more software agents, compliance of the endpoint devices against a security standard. The security standard can be associated with internal policies; regulatory, audit, or third-party organization recommendations; and so on. The security standards can include the ISO 27000 series, NIST SP 800-53, NIST SP 800-171, COBIT, CIS Version 8, HITRUST, and so on. Recommendations from the third-party application vendor can be used as a security standard. The checking can be based on a schedule. The schedule can be set for individual third-party applications or can be based on a standard for application types. In embodiments, the schedule can include software patches and updates from the third-party application vendors, operating system vendors, etc. The orchestration software can maintain an inventory of current updates, patches, and installation programs for the software installed on the endpoints included in the technology coverage 410 umbrella and compare the versions of applications installed on the endpoint devices to the most current versions of each application. The summarized information regarding upgrade and patching levels is displayed as a patching indicator 460 in the technology coverage example 410. In the example, the overall patching level indicates that 84% of the endpoint devices have the most current versions of applications patches installed.

The example 400 includes summarizing, by the orchestration software, the plurality of security information details from the first software agent. Summarized information can include the number of endpoint devices on the network, number of active endpoint devices, etc. Embodiments may include number of security related events, number of blocked commands, number of allowed commands, and so on. The summarizing can include listing the state of the one or more third-party applications running on the first endpoint device. The state of the one or more third-party applications can include an identification of a suspicious activity, a software version, or a connection status. In embodiments, the summary of endpoint devices can include groups based on the type of device, departments, locations, types of incidents reported, and so on. The user can review the summarized categories and expand the summary to view details down to the individual endpoint device. In embodiments, the user can choose the summarized categories to display in a list or in graphic form. The list can be sorted as the user chooses. The order of the graphic indicators can be arranged by the user, as well as the color and patterns used within the indicators.

In embodiments, the summarized information for the one or more third-party applications includes antivirus software, endpoint detection and response (EDR) software 440, incident response software, anti-ransomware, or advanced persistent threat (APT) software. The one or more third-party applications can include security information and event management (SIEM) software, cloud security information and event management software, and patching software. In the example 400, the anti-ransomware indicator 420 shows that 95% of the endpoint devices included in the technology coverage umbrella have the anti-ransomware agent properly installed. In the example 400, the cloud SIEM 430 indicators show that there are no alerts or other indicators of suspicious activity present for any endpoint devices connected to the network via a cloud connection. On the other hand, the SIEM indicator 470 shows that 3% of the endpoint devices connected to the on-premises network are showing an alert or some other form of suspicious activity at the present time. In embodiments, some of the suspicious activity can be related to an incomplete patching in process, or there can be some other form of activity taking place.

In the example 400, the endpoint detection and response (EDR) 440 indicator shows that 92% of the endpoint devices included in the technology coverage umbrella have the EDR application correctly installed and are communicating with the software agent. The advanced persistent threat (APT) indicator 450 shows that there are currently no advanced threats being detected across the network. In embodiments, a user can mouse-click on one or more of the summary indicators and drill down into the data supporting the aggregated percentages. In some embodiments, the data can be broken down by location, device type, operating system version, third-party application, suspicious activity, threat level, and so on. In some embodiments, the user can drill down to the individual endpoint device and make decisions regarding the management of the endpoint.

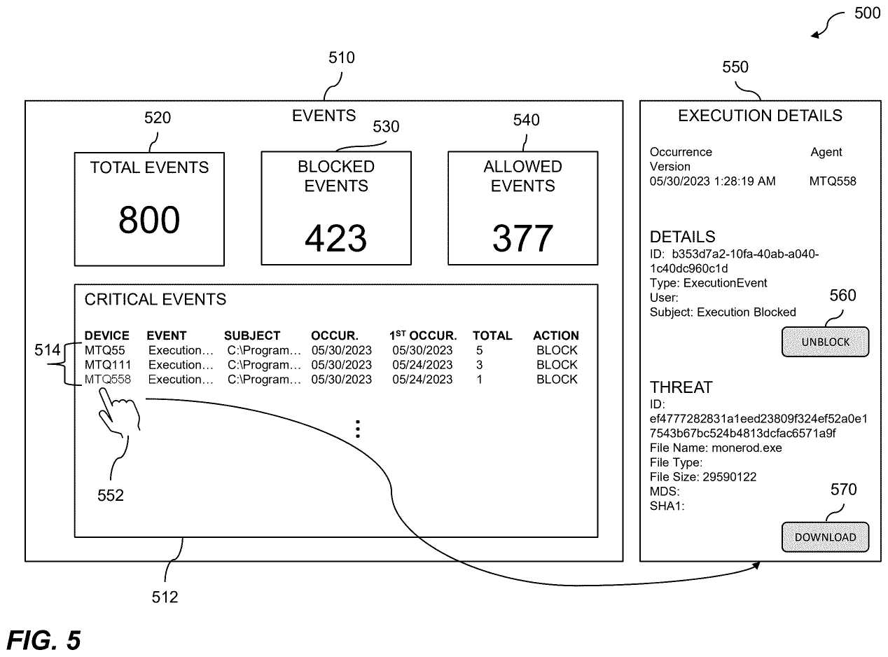

FIG. 5 is an example of blocking suspicious activity. Blocking suspicious activity can be enabled by proactive security assessment with agent-based cybersecurity deployment. A software agent is installed on each endpoint device within a plurality of endpoint devices. Each software agent manages a unique endpoint device. Each software agent is communicatively coupled to an orchestration software component. The software agents monitor security activities on each endpoint device and send security information details on the endpoint device to the orchestration software. The orchestration software generates security categories and a compliance score in each category for each endpoint device. The orchestration software creates a proactive security score (PSS) for each endpoint device, based on the security information compliance scores. The orchestration software generates a global proactive security score (GPSS) based on the average PSS for the plurality of endpoint devices. The orchestration software reports the PSS and GPSS for the plurality of endpoint devices.

The example 500 can include summarizing, by the orchestration software, the plurality of security information details from the first software agent. The example 500 can further comprise monitoring, by a second software agent installed on a second endpoint device within the plurality of endpoint devices, an activity by one or more third-party applications on the second endpoint device; sending, to the orchestration software, by the second software agent, a plurality of security information details, wherein the plurality of security information details includes the activity that was monitored; and summarizing, by the orchestration software, the plurality of security information details from the second software agent. In embodiments, the orchestration software can aggregate the plurality of security information details and events 510 from all software agents installed on the plurality of endpoint devices in the network. The summarizing can include event categories including total events 520, blocked events 530, and allowed events 540.

The example 500 can include a list of critical events 512 generated by one or more endpoint devices and detected by the one or more third-party applications running on the endpoint devices. The critical events can include one or more suspicious activities detected by the one or more third-party applications. The example 500 can include quantifying the suspicious activity and providing results of the quantifying to the orchestration software. In the example 500, three endpoint devices are listed 514. Each occurrence includes the name of the endpoint device, the type of event detected, the file or program comprising the subject of the event, the date of the most recent occurrence, the date of the first occurrence, the total number of times the event has occurred on the endpoint device, and the action or actions taken by the orchestration software in response to the event.

The example 500 includes monitoring, by a first software agent installed on a first endpoint device within the plurality of endpoint devices, an activity by the one or more third-party applications on the first endpoint device. In the example 500, a user has selected 552 endpoint device MTQ558 to view execution details 550 related to the device. In embodiments, the plurality of security information details can include a hostname, IP address, kernel, agent version, agent status, or most recent internet connection. In the example 500, the execution details 550 show the date and time of the occurrence; the agent name; details from a security log including the ID of the event, the type of event, a threat ID, the file name, and/or file size; and so on. The user is given the option of unblocking 560 the execution of the file monerod.exe and downloading 570 a copy of the file into a sandbox or other type of secured file area for further inspection and testing.

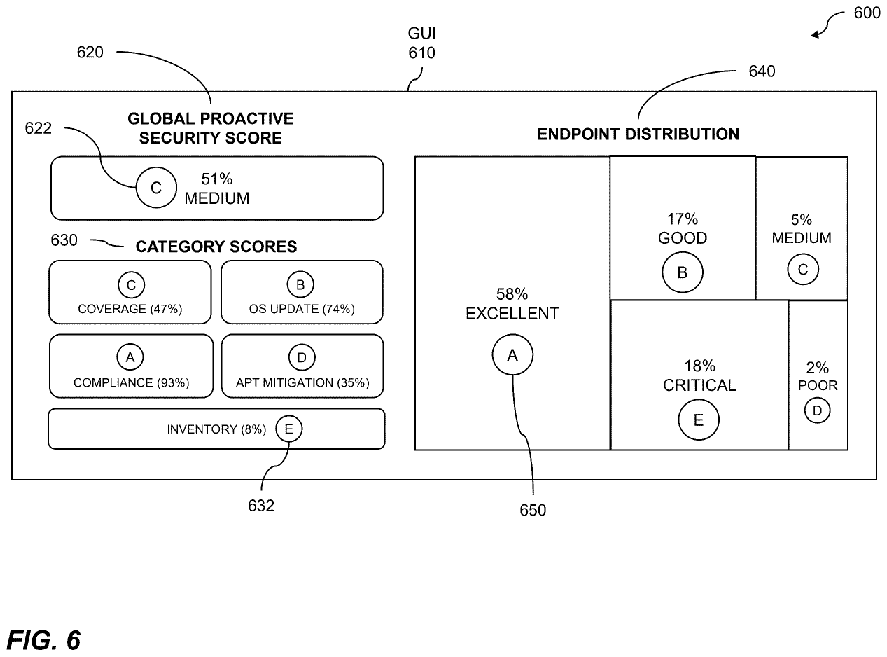

FIG. 6 is an example graphical user interface for presenting proactive security scores. Proactive security scores can be provided by proactive security assessment with agent-based cybersecurity deployment. A software agent is installed on each endpoint device within a plurality of endpoint devices. Each software agent manages a unique endpoint device. Each software agent is communicatively coupled to an orchestration software component. The software agents monitor security activities on each endpoint device and send security information details on the endpoint device to the orchestration software. The orchestration software generates security categories and a compliance score in each category for each endpoint device. The orchestration software creates a proactive security score (PSS) for each endpoint device, based on the security information compliance scores. The orchestration software generates a global proactive security score (GPSS) based on the average PSS for the plurality of endpoint devices. The orchestration software reports the PSS and GPSS for the plurality of endpoint devices.

The example 600 includes a graphical user interface (GUI) 610 which presents proactive security scores (PSS) created by an orchestration software. The proactive security scores can be created based on security information details collected by software agents installed on a plurality of endpoint devices included in a network. The software agents can monitor the endpoint devices and send information on security activities to the orchestration software. The orchestration software can separate the endpoint security information into security categories. The orchestration software can generate a compliance score for each endpoint device in each security category. The orchestration software can generate an average compliance score for various subsets of the endpoint device population and for the entire endpoint device population. The compliance scores can be used to calculate the proactive security scores based on a weighted average of the compliance scores. The weights used to calculate the PSS can be set by a user or administrator of the orchestration software. The GUI can be used by an orchestration software user to display information generated by the orchestration software at various levels of the network.

The example 600 includes a global proactive security score 620. In embodiments, the GPSS comprises an average of the PSS of the plurality of endpoint devices included in the network accessed by the orchestration software. In the example 600, the GPSS is 51% medium. In the example, the GPSS has also been assigned a letter score of C 622. The orchestration software can be configured by the user to assign labels and letters to various ranges of GPSS percentages. For example, a GPSS of 41% to 60% can be assigned a label of “medium” or “average” and a letter score of “C.” A GPSS of 25% to 40% can be assigned a label of “poor” and a letter score of “D,” and so on.

The example 600 includes a group of category scores 630 that contribute to the overall GPSS. In the example 600, the category scores have each been given a letter score similar to the overall GPSS. The coverage category, which can represent the number of endpoints running the cybersecurity technology components used by the network operators, is 47%, receiving a letter score of “C.” The user can weight certain technology so that the average is tilted in favor of those components. For example, five applications may be monitored on a device by a software agent. But one application, for example virus protection, can be weighted more than 20%, while some other software can be weighted a lower percentage. Thus, any data, percentage, etc. reported can be customized. The OS update category, which can show the number of endpoint devices running the most up-to-date system updates related to cybersecurity vulnerabilities, is 74%, receiving a letter score of “B.” The compliance score, which can represent the strength of the security controls implemented across the endpoint device population is 93%, receiving a letter score of “A.” The compliance controls can be calculated based on security controls included in the orchestration software or configured by the software users. The APT mitigation score can represent the number and criticality of potentially vulnerable devices within the endpoint device population, based on known attack vectors and malicious actors. In the example, the APT mitigation is 35%, representing a score of “D.” The inventory score of 8% can represent the number of endpoint devices for which a complete hardware and software inventory has been received by the orchestration software. In the example, the inventory score is 8%, receiving a letter score of “E” 632.

The example 600 includes an endpoint distribution section 640. This section can be used to display the percentage of endpoint devices with PSS scores in various ranges. The size of the box surrounding each letter grade can be adjusted by the software to reflect the percentage of endpoints in each category. The example 600 shows 58% of the total endpoint device population with a PSS in the excellent category, receiving a letter score of “A” 650. The orchestration software can be configured by an administrator to adjust the percentage PSS score which qualifies for each of the letter categories. The example 600 shows 17% of the endpoint device population with a PSS score in the good category, receiving a “B” letter score. 5% of the endpoint device population are shown to be in the medium category with a letter score of “C.”2% of the endpoint device population receives a score of “D” or poor, and 18% of the endpoint device population receives a score of “E” or critical. The GUI user can click on any box within the endpoint distribution 640 or category scores 630 section and view details of the endpoint devices with PSS scores included in the section. In some embodiments, the orchestration software user can make direct changes to the endpoint devices in order to address cybersecurity issues brought out by the software.

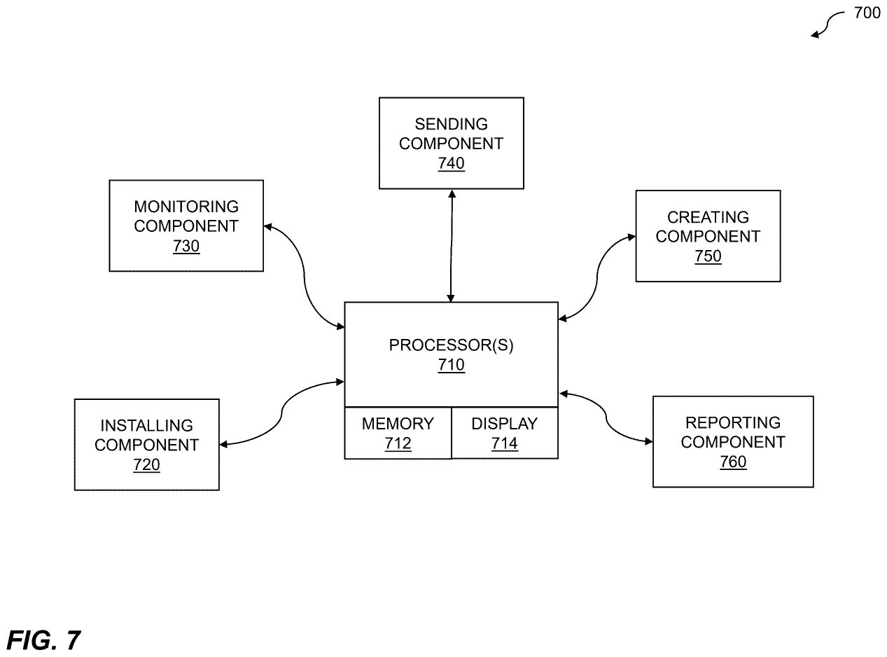

FIG. 7 is a system diagram for proactive security assessment with agent-based cybersecurity deployment. The system 700 can include one or more processors 710 coupled to a memory 712 which stores instructions. The system 700 can include a display 714 coupled to the one or more processors 710 for displaying data, video streams, videos, intermediate steps, instructions, and so on. In embodiments, one or more processors 710 are coupled to the memory 712 where the one or more processors, when executing the instructions which are stored, are configured to: install a software agent on each endpoint device within a plurality of endpoint devices, wherein each software agent manages a unique endpoint device within the plurality of endpoint devices, and wherein each software agent is communicatively coupled to an orchestration software running on a compute device; monitor, by a first software agent installed on a first endpoint device within the plurality of endpoint devices, one or more security activities on the first endpoint device; send, to the orchestration software, by the first software agent, a plurality of security information details, wherein the plurality of security information details is based on the monitoring; create, by the orchestration software, a first proactive security score (PSS) for the first endpoint device, wherein the PSS is based on the plurality of security information details; and report, to a user, by the orchestration software, the first PSS for the first endpoint device.

The system 700 includes an installing component 720. The installing component 720 includes functions and instructions for installing a software agent on each endpoint device within a plurality of endpoint devices. The software agents can be persistent—they can be proactive and reactive, and they can act independently or in collaboration with other software components on the same device or other devices. Each software agent manages a unique endpoint device within the plurality of endpoint devices. The endpoint devices can be personal computers, laptops, thin-client workstations, tablets, mobile phones, IoT devices, network components, and so on. The endpoint device connections can be wired or wireless. Each software agent is communicatively coupled to an orchestration software running on a compute device. The communicative coupling can be included in a network. The network environment can be local, cloud, hybrid clouds, etc.

The system 700 includes a monitoring component 730. The monitoring component 730 includes functions and instructions for monitoring, by a first software agent installed on a first endpoint device within the plurality of endpoint devices, one or more security activities on the first endpoint device. In embodiments, the one or more security activities that were monitored are associated with one or more third-party applications. The monitoring can include reviewing log entries generated by the third-party applications, communications sent to or from the third-party application to a server or cloud-based control application, alerts generated by a third-party agent on the endpoint device, and so on. In embodiments, the one or more security activities that were monitored are based on a state of the first endpoint device. The state of the first endpoint device can include the power state of the device, network activity, drivers loaded or active, applications in memory, drive activity, and so on. The first endpoint device state information can be used to determine when third-party software processes can be executed, such as virus scans or patch installations. The state information can be used to determine whether an endpoint device is attached to the network and available for scanning or updating, and so on.

The system 700 includes a sending component 740. The sending component 740 includes functions and instructions for sending, to the orchestration software, by the first software agent, a plurality of security information details. The plurality of security information details is based on the monitoring. The plurality of security information details can include the endpoint device hostname, IP address, kernel, agent version, agent status, most recent internet connection, and so on. Information about the type of endpoint device, operating system, network connection, physical location, etc. can be included in the plurality of security information details. The plurality of security information details can be refreshed based on a schedule established by the orchestration software. Alerts and other responses to suspicious activity or security incidents can be sent to the orchestration software as soon as the responses are generated by the software agent on the endpoint device. The first software agent can communicate with the orchestration software asynchronously. This can allow the orchestration software the ability to communicate with multiple endpoint devices simultaneously and coordinate actions to remedy security incidents quickly and efficiently.

The system 700 includes a creating component 750. The creating component 750 includes functions and instructions for creating, by the orchestration software, a first proactive security score (PSS) for the first endpoint device. The PSS is based on the plurality of security information details. In embodiments, the first PSS is based on a weighted average of each compliance score that was generated. The weighted average can be adjusted based on internal policies, compliance policies, third-party software recommendations, audit standards, and so on. For example, adherence to operating system configuration requirements can be weighted more highly than hardware age or network speed, and so on.

The system 700 includes a reporting component 760. The reporting component 760 includes functions and instructions for reporting, to a user, by the orchestration software, the first PSS for the first endpoint device. The reporting can be generated for the first endpoint device, the second endpoint device, or any endpoint device within the network which includes the orchestration software. The reporting can be generated for the entire endpoint device population as well as various subsets of the endpoint device population. The reporting can be generated in various formats, including print, pdf, html, txt, csv, and so on. The reporting can be presented in screen formats. The reporting can include a GUI. The reporting can be generated dynamically. The reporting can be generated on one or more schedules supplied by an orchestration software user or administrator.

The system 700 can include a computer program product embodied in a non-transitory computer readable medium for audio analysis, the computer program product comprising code which causes one or more processors to perform operations of: installing a software agent on each endpoint device within a plurality of endpoint devices, wherein each software agent manages a unique endpoint device within the plurality of endpoint devices, and wherein each software agent is communicatively coupled to an orchestration software running on a compute device; monitoring, by a first software agent installed on a first endpoint device within the plurality of endpoint devices, one or more security activities on the first endpoint device; sending, to the orchestration software, by the first software agent, a plurality of security information details, wherein the plurality of security information details is based on the monitoring; creating, by the orchestration software, a first proactive security score (PSS) for the first endpoint device, wherein the PSS is based on the plurality of security information details; and reporting, to a user, by the orchestration software, the first PSS for the first endpoint device.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for endpoint security comprising:
installing a software agent on each endpoint device within a plurality of endpoint devices, wherein each software agent manages a unique endpoint device within the plurality of endpoint devices, and wherein each software agent is communicatively coupled to an orchestration software running on a compute device;
monitoring, by a first software agent installed on a first endpoint device within the plurality of endpoint devices, one or more security activities on the first endpoint device;
sending, to the orchestration software, by the first software agent, a plurality of security information details, wherein the plurality of security information details is based on the monitoring;
creating, by the orchestration software, a first proactive security score (PSS) for the first endpoint device, wherein the PSS is based on the plurality of security information details; and
reporting, to a user, by the orchestration software, the first PSS for the first endpoint device.

2. The method of claim 1 wherein the one or more security activities that were monitored are associated with one or more third-party applications.

3. The method of claim 1 wherein the one or more security activities that were monitored are based on a state of the first endpoint device.

4. The method of claim 1 further comprising associating the plurality of security information details with one or more security categories.

5. The method of claim 4 further comprising generating, for each security category in the one or more security categories, a compliance score.

6. The method of claim 5 wherein each compliance score is based on a security standard.

7. The method of claim 5 wherein each compliance score is associated with the first endpoint device.

8. The method of claim 5 wherein the first PSS is based on a weighted average of each compliance score that was generated.

9. The method of claim 8 wherein the one or more security categories includes coverage.

10. The method of claim 8 wherein the one or more security categories includes compliance.

11. The method of claim 8 wherein the one or more security categories includes operating system (OS) updates.

12. The method of claim 8 wherein the one or more security categories includes advanced persistent threat (APT) mitigation.

13. The method of claim 8 wherein the one or more security categories include an inventory.

14. The method of claim 8 wherein the monitoring, the sending, the creating, and the reporting include a second endpoint device.

15. The method of claim 14 wherein the creating includes a second PSS for the second endpoint device.

16. The method of claim 15 further comprising determining a global proactive security score (GPSS), wherein the GPSS comprises an average of the first PSS and the second PSS.

17. The method of claim 16 wherein the generating includes a second compliance score, wherein the second compliance score is associated with the second endpoint device.

18. The method of claim 17 further comprising calculating one or more security category scores.

19. The method of claim 18 wherein the one or more security category scores comprise, for each security category in the one or more security categories, an average of the compliance score and the second compliance score.

20. A computer program product embodied in a non-transitory computer readable medium for instruction execution, the computer program product comprising code which causes one or more processors to perform operations of:
installing a software agent on each endpoint device within a plurality of endpoint devices, wherein each software agent manages a unique endpoint device within the plurality of endpoint devices, and wherein each software agent is communicatively coupled to an orchestration software running on a compute device;
monitoring, by a first software agent installed on a first endpoint device within the plurality of endpoint devices, one or more security activities on the first endpoint device;
sending, to the orchestration software, by the first software agent, a plurality of security information details, wherein the plurality of security information details is based on the monitoring;
creating, by the orchestration software, a first proactive security score (PSS) for the first endpoint device, wherein the PSS is based on the plurality of security information details; and
reporting, to a user, by the orchestration software, the first PSS for the first endpoint device.

21. A computer system for instruction execution comprising:
a memory which stores instructions;
one or more processors coupled to the memory, wherein the one or more processors, when executing the instructions which are stored, are configured to:
install a software agent on each endpoint device within a plurality of endpoint devices, wherein each software agent manages a unique endpoint device within the plurality of endpoint devices, and wherein each software agent is communicatively coupled to an orchestration software running on a compute device;
monitor, by a first software agent installed on a first endpoint device within the plurality of endpoint devices, one or more security activities on the first endpoint device;
send, to the orchestration software, by the first software agent, a plurality of security information details, wherein the plurality of security information details is based on the monitoring;
create, by the orchestration software, a first proactive security score (PSS) for the first endpoint device, wherein the PSS is based on the plurality of security information details; and
report, to a user, by the orchestration software, the first PSS for the first endpoint device.
